(19) United States
(12) Patent Application Publication
(10) Pub. No.: US 2002/0140269 A1
(43) Pub. Date: Oct. 3, 2002

(54) Clamping device for controlling rotation of a chair about a support shaft of a base frame

(75) Inventors: Guy Laverdiere, Ville Lasalle (CA); Marc Hoffman, Montreal (CA); Charles Mercier, Montreal (CA)

Correspondence Address: DARBY & DARBY P.C., 805 Third Avenue, New York, NY, 10022, US

(73) Assignee: SILHOUET-TONE LTEE

(21) Appl. No.: 10/040,247

(22) Filed: Jan. 4, 2002

(30) Foreign Application Priority Data
Jan. 4, 2001 (CA) 2,330,073

(51) Int. Cl. B60N 2/02

(52) U.S. Cl. 297/374

(57) ABSTRACT

A clamping device for controlling rotation of a chair about a support shaft of a base frame and the chair associated thereto. The clamping device includes a mounting block, clamping components, and calibrating components. The mounting block is securely affixed to a bottom portion of the chair and has first and second channels transversely connected to one another inside the mounting block. The mounting block is pivotably mountable onto a portion of the support shaft and is allowed to rotate thereabout. This portion is insertable into the first channel of the mounting block. The clamping components are mounted into the second channel of the mounting block and are operatively connected to the support shaft for clamping the same. The calibrating components are operatively connected to the clamping components for adjusting the extent with which the clamping components clamp the support shaft. The present clamping device provides a wide range of adjustable positions without any backlash. The present clamping device allows the chair to be rotated in a controlled and adjustable manner through a wide rotational range.

### FIELD OF THE INVENTION

The present invention relates to a clamping device. More particularly, the present invention relates to a clamping device for controlling rotation of a chair about a support shaft of a base frame.

### BACKGROUND OF THE INVENTION

Chairs such as clinical chairs and the like are very well known in the art. These chairs are generally devised for accommodating a person, such as “patient” for example, and are used for various purposes, such as aesthetic applications, medical applications, etc. The above-mentioned type of chair generally has a base frame which is usually fixed to the ground surface, and the chair is mounted onto the base frame and generally further devised to be adjustable spatially with respect to the base frame so as to appropriately position the patient lying on the clinical chair with respect to an operator of the chair, usually a professional treating the patient. Examples of such professionals are aestheticians, dentists, massagetherapists, etc., as is well known in the art.

It is also well known in the art that clinical chairs usually may comprise a seat, a backrest, a headrest, a leg support, and side arms. Very often, one or several of these components need to be rotated with respect to the chair so as to allow the patient to take on a comfortable position while he or she is being treated, but more particularly also, to ensure proper and steady positioning of the patient in order to facilitate the work of the professional treating the patient. In order to achieve such a result, it is also known that very often the chair itself, as aforementioned, needs to be displaced with respect to the base frame. Indeed, the chair usually needs to be movable spatially, in a mutually orthogonal 3-axis coordinate system for example, i.e. vertically along a z-axis, longitudinally along a y-axis, and transversely along an x-axis and/or may also further need to be tilted, i.e. rotated, about one or several of these axes, so as to allow many degrees of freedom.

Known in the art are devices for allowing the chair to rotate about a z-axis, such as a vertical support shaft of a base frame for example. Chairs which are devised to rotate freely about the support shaft of the base frame, such as some clinical chairs and swivel chairs, are one example thereof. Also known in the art are the problems associated with the abovementioned types of chairs. Firstly, they often require a lock/release mechanism to be able to maintain the chair in a fixed rotational position. Because these types of lock/release mechanisms are generally apparatuses which project well out of the base frame and are thus quite cumbersome, a covering shell for the base frame can therefore not be used generally. As it is known, a covering shell is a protective cover generally devised to conceal different actuating mechanisms which are used to set the chair into various positions and configurations as well as to conceal the general base frame structure for aesthetic reasons, among others. Should a covering shell be used with the above-mentioned type of lock/release mechanism, a great opening in the covering shell would be required so as to allow the outwardly projecting components of the lock/release mechanism to move freely about the opening when the chair is rotated so as to not interfere with the rest of the covering shell; otherwise, damages often result to the covering shell and/or to the lock/release mechanism. Furthermore, because such lock/release mechanisms are generally affixed to the chair and that the chair is generally devised to go through wide ranges of motions (tilt, swivel, etc.), a covering shell often cannot be used with the lock-release mechanisms and/or a great opening for its outwardly projecting components must be used which is very undesirable for obvious reasons known in the art.

Also known in the art are lock/release mechanisms which may be located inside a covering shell of the base frame, that is, which do not have extensive outwardly projecting components, but these mechanisms are generally very sophisticated and as a result are generally very costly and difficult to maintain. Their elaborate construction often results in failures and break downs of the device which is also very undesirable.

Therefore, it would be useful to provide a clamping device for rotation of a chair about a support shaft of a base frame which would resolve some of the above-mentioned problems associated to the devices and chairs known in the art.

Also known in the art are devices which are used to adjust and control such a rotation about a vertical axis. However, a major problem associated with these devices is that they consist of ratchet mechanisms which only allow the chair to rotate about a vertical axis through a definite amount of predetermined positions. Moreover, because of their construction, the above-mentioned devices also have a backlash associated to each of their positions, which is also very undesirable for obvious reasons. Indeed, a jittering of the patient and/or an accidental pump by the operator onto the chair often causes the latter to become misplaced, that is to rotate about the vertical axis out of a desired position due to the backlash inherent to ratchet mechanisms. Another disadvantage of these devices is that an outwardly projecting crank is usually required for calibrating and adjusting such ratchet mechanisms. As it is known in the art, the crank of such devices usually projects from an orifice of a covering shell of the base frame. The covering shell is generally devised to conceal the different actuating mechanisms which are used to set the chair into various positions and configurations. Consequently, it is known that when the chair is rotated about the vertical axis, the crank will rotate along with the chair thereby hitting against the covering shell of the base frame, thereby causing it to warp and thus damaging it.

Therefore, it would be useful to provide a clamping device for controlling rotation of a chair about a support shaft of a base frame which would enable to provide a wide range of adjustable positions without any backlash.

Known to the Applicant are the following American patents which describe different clamping devices: U.S. Pat. Nos. 4,055,320; 4,466,203; 4,536,102; 4,639,036; 4,693,514; 4,919,379; 5,295,731; 5,441,067; 5,588,706; 5,593,205; and 6,302,482.

None of the above-mentioned patents seem to disclose or even suggest a clamping device for controlling rotation of a chair about a support shaft of a base frame which would overcome several of the above-mentioned problems associated with the prior art.

### SUMMARY OF THE INVENTION

An object of the present invention is to provide a clamping device for controlling rotation of a chair about a support shaft of a base frame which would satisfy some of the above-mentioned needs, and would thus be an improvement over the chair clamping devices known in the art.

In accordance with the invention, the above object is achieved by a clamping device for controlling rotation of a chair about a support shaft of a base frame, the clamping device comprising:

a mounting block securely affixed to a bottom portion of the chair, the mounting block having first and second channels being transversally connected to one another inside the mounting block, the mounting block being pivotably mountable onto a portion of the support shaft and allowed to rotate thereabout, the portion being insertable into the first channel of the mounting block;

clamping means mounted into the second channel of the mounting block and operatively connected to the support shaft for clamping the same; and

calibrating means operatively connected to the clamping means for adjusting the extent with which the clamping means clamp the support shaft.

Preferably, the clamping means comprise first and second jaws biased against each other so as to clamp the support shaft thereinbetween, and the calibrating means comprise biasing means for biasing the first and second jaws towards one another against the support shaft.

Preferably also, the support shaft comprises at least one stopper positioned to cooperate with a peripheral border of a recessed cavity of the mounting block.

According to the present invention there is also provided a chair comprising a clamping device for controlling rotation of the chair about a support shaft of a base frame, the clamping device comprising:

a mounting block securely affixed to a bottom portion of the chair, the mounting block having first and second channels being transversally connected to one another inside the mounting block, the mounting block being pivotably mountable onto a portion of the support shaft and allowed to rotate thereabout, the portion being insertable into the first channel of the mounting block;

clamping means mounted into the second channel of the mounting block and operatively connected to the support shaft for clamping the same; and

calibrating means operatively connected to the clamping means for adjusting the extent with which the clamping means clamp the support shaft.

The invention and its advantages will be better understood by reading the following non-restrictive description of preferred embodiments thereof, made with reference to the accompanying drawings.

### BRIEF DESCRIPTION OF THE DRAWINGS

FIG. 1 is a side perspective view of a clinical chair according to the prior art.

FIG. 2 is a schematic perspective view of a chair comprising a clamping device according to a preferred embodiment of the invention, said chair being shown in an intermediate configuration and in a central position.

FIG. 3 is an enlarged view of the clamping device shown in FIG. 2, said clamping device being shown cooperating with the support shaft of the chair.

FIG. 4 is an enlarged view of what is shown in FIG. 3.

FIG. 5 is an exploded view of what is shown in FIG. 3.

FIG. 6 is an exploded view of a clamping device according to another preferred embodiment of the invention, said clamping device being shown cooperating with the support shaft of FIG. 2.

FIG. 7 is another view of FIG. 6.

FIG. 8 is yet another view of FIG. 6.

FIG. 9 is a schematic plan view of a base frame of a chair comprising z-axis locking mechanisms according to the prior art.

FIG. 10 is a schematic plan view of a base frame of a chair according to another embodiment of the prior art.

FIG. 11 is a schematic perspective view of the chair using a ratchet mechanism according to the prior art.

FIG. 12 is a schematic plan view of cooperations between clamping devices and support shafts of base frames according to different other embodiments of the invention.

### DETAILED DESCRIPTION OF PREFERRED EMBODIMENTS OF THE INVENTION

In the following description, the same numeral references refer to similar elements.

Moreover, although the present invention was primarily designed for a clamping device for adjusting rotation of a clinical chair about a vertical support shaft of a base frame, it could be used with other types of objects of different fields, e.g. chairs of amusement park rides, chairs used for passengers traveling in planes, trains, and the like, etc., as apparent to a person skilled in the art. For this reason, expressions such as “clinical” and/or “vertical” and any other references and/or other expressions equivalent thereto should not be taken as to limit the scope of the present invention and include all other objects with which the present invention could be used and may be useful.

In addition, although the preferred embodiment of the present invention as shown comprises components such as a spring, a bolt, a calibration stop block, etc., not all of these components are essential and thus should not be taken in their restrictive sense, i.e. should not be taken as to limit the scope of the present invention. It is to be understood, as also apparent to a person skilled in the art, that other suitable components and cooperations thereinbetween may be used for the clamping means and the calibrating means of the clamping device according to the present invention, as will be explained hereinafter, without departing from the scope of the invention.

Moreover, expressions such as “bolt” and “screw”, as well as any equivalent expressions and/or compound words thereof, may be used interchangeably in the context of the present description. The same applies for any other mutually equivalent expressions, such as “axis” and “shaft” for example, or “calibrating” and “biasing”, as also apparent to a person skilled in the art.

The clamping device 1 according to the preferred embodiments of the invention shown in the accompanying drawings is a clamping device 1 for controlling rotation of a chair 3 about a support shaft 5 of a base frame 7. The clamping device 1 comprises a mounting block 9, clamping means 11 and calibrating means 13.

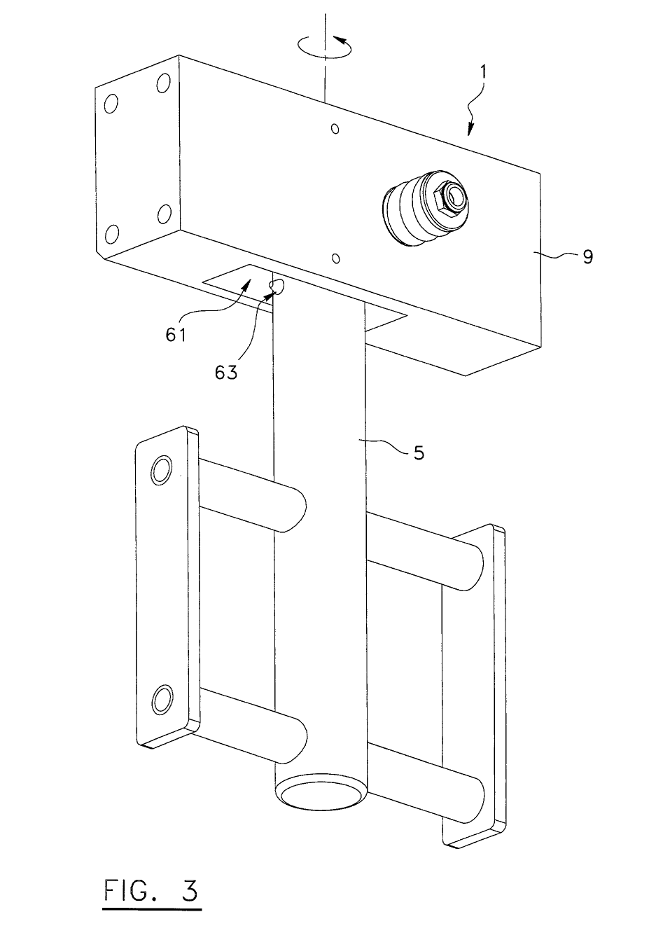

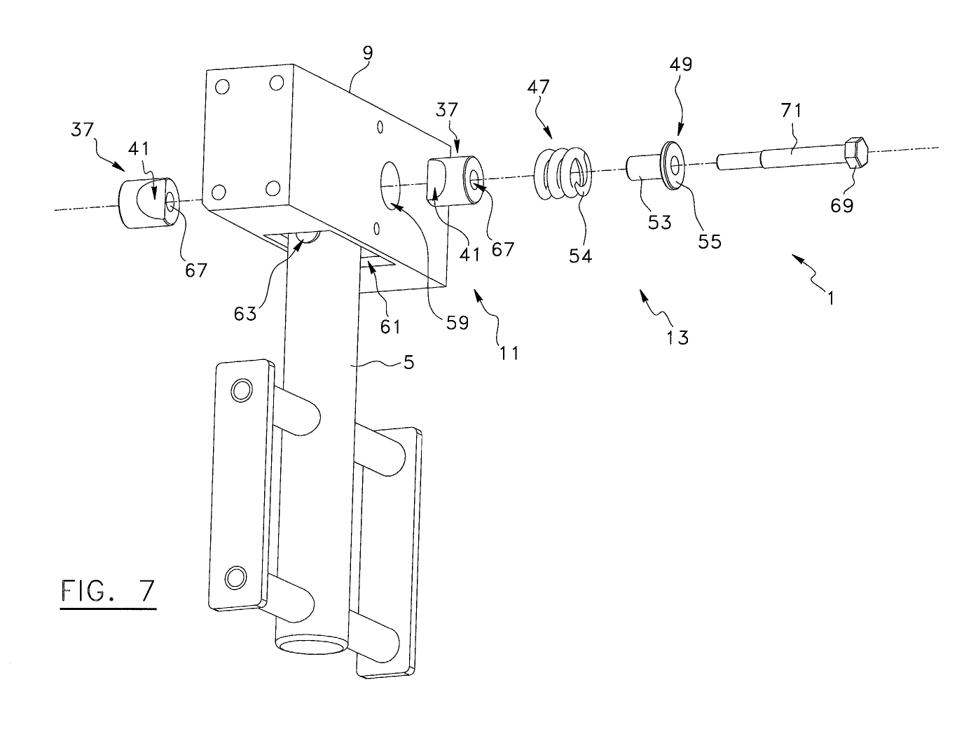

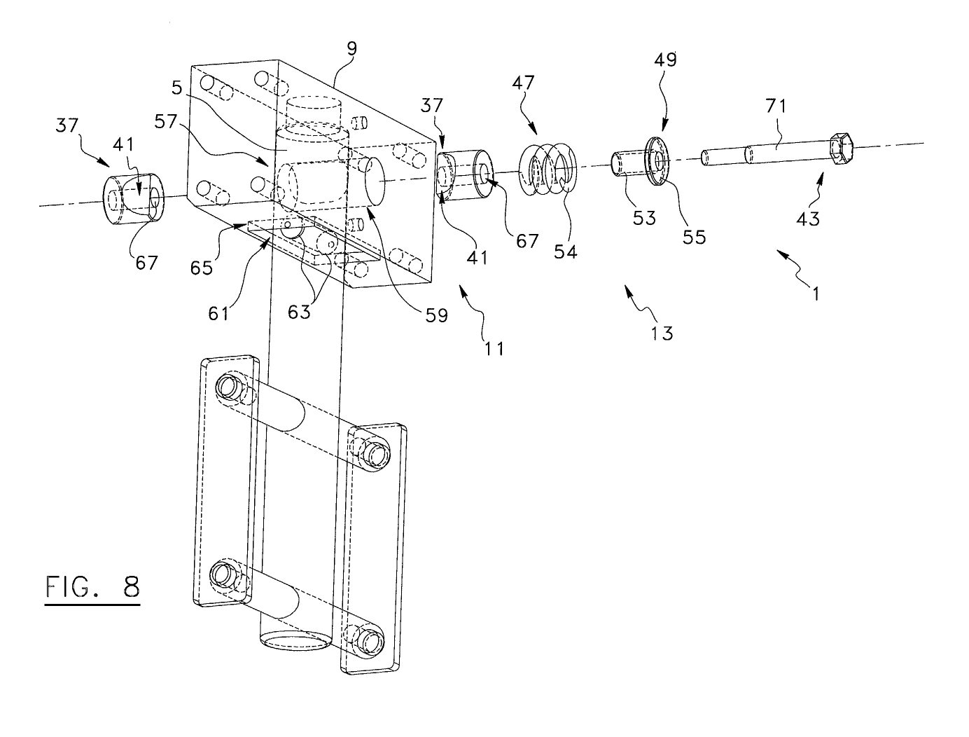

The mounting block 9 is securely affixed to a bottom portion of the chair 3, and has first and second channels 57, 59 being transversally connected to one another inside the mounting block 9, as better shown in FIG. 8. The mounting block 9 is pivotably mountable onto a portion of the support shaft 5 and is allowed to rotate thereabout, this portion being insertable into the first channel 57 of the mounting block 9, as better shown in FIGS. 3-8.

The clamping means 11 are mounted into the second channel 59 of the mounting block 9 and are operatively connected to the support shaft 5 for clamping the same, as also shown.

The calibrating means 13 are operatively connected to the clamping means 11 for adjusting the extent with which the clamping means 11 clamp the support shaft 5.

As better shown in FIGS. 3-8, the clamping means 11 preferably comprise first and second jaws 37 biased against each other so as to clamp the support shaft 5 thereinbetween, and the calibrating means 13 preferably comprise biasing means for biasing the first and second jaws 37 towards one another against the support shaft 5.

Preferably, the biasing means comprise a nut 45 and a bolt 43 having first and second ends, the first end of the bolt 43 being insertable into the nut 45, and the jaws 37 being mounted about the bolt 43 between the nut 45 and the second end of the bolt 43. Preferably also, the biasing means further comprise a spring 47 mounted coaxially about the bolt 43, said spring 47 being positioned adjacent to one of the jaws 37 in an abutment relationship therewith. Preferably also, the biasing means further comprise a calibration stop block 49 mounted coaxially about the bolt 43, said stop block 49 being positioned adjacent to the spring 47 in an abutment relationship therewith.

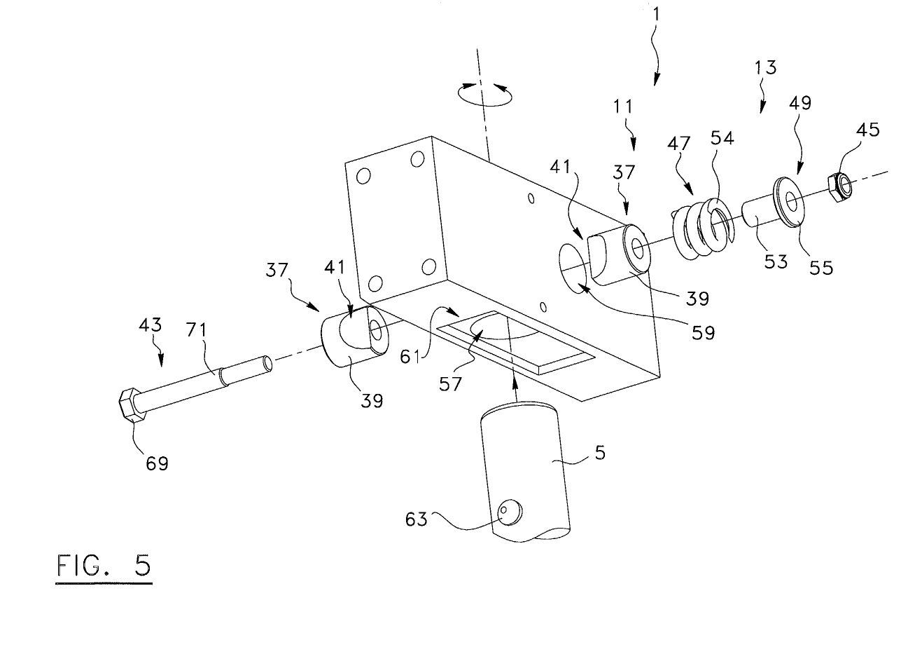

As better shown in FIGS. 5-8, the calibration stop block 49 preferably comprises a main body 53 having first and second ends and a flange 55 in an abutment relationship with the spring 47, the first end of main body 53 resting against the jaw 37 adjacent to the spring 47 and the flange 55 being securely affixed to the second end of the main body 53. Preferably also, the spring 47 is further mounted coaxially about the main body 53 of the stop block 49 between the first end of the main body 53 and its flange 55.

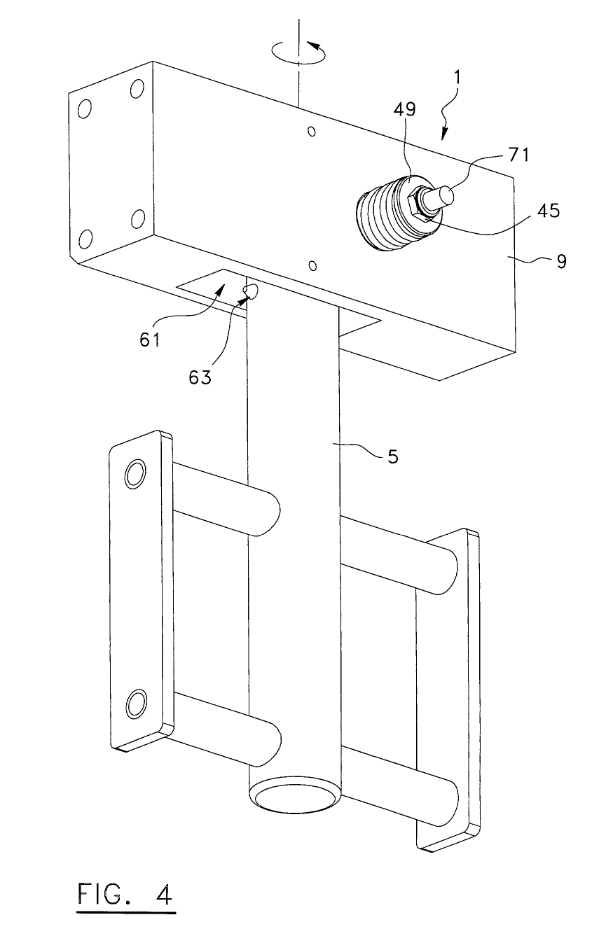

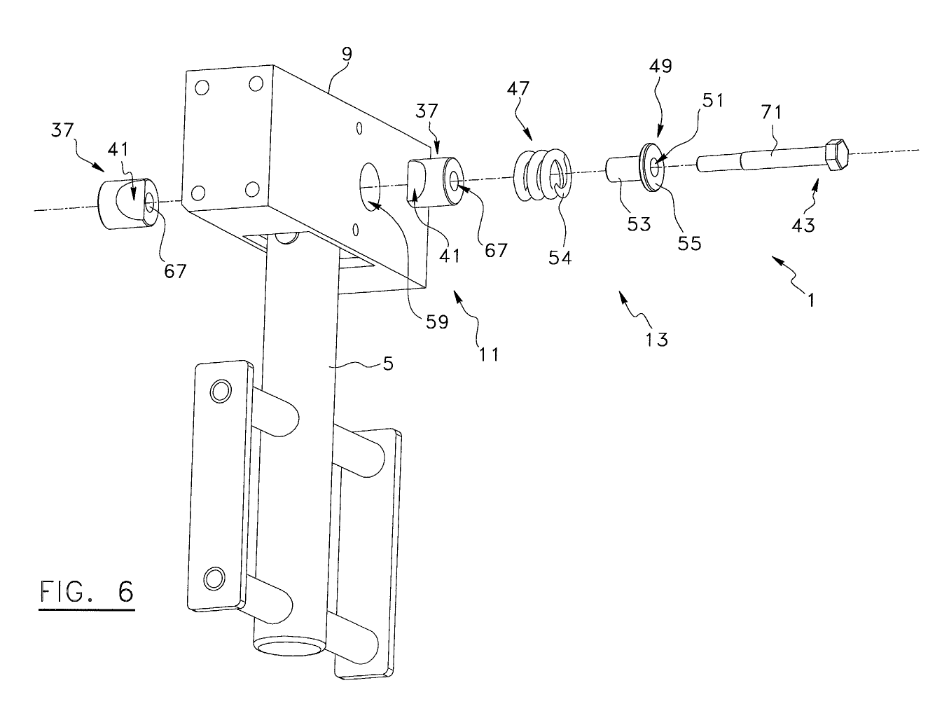

As better shown in FIGS. 6-8, one of the jaws 37 and the nut 45 may be integral to one another, i.e. one of the jaws 37 may act as a nut 45, as apparent to a person skilled in the art. Preferably also, the support shaft 5 is cylindrical and the jaws 37 comprise suitable clamping surfaces 41 matching the contour of the support shaft 5. Preferably also, the support shaft 5 comprises at least one stopper 63 positioned to cooperate with a peripheral border 65 of a recessed cavity 61 of the mounting block 9, as better shown in FIG. 4.

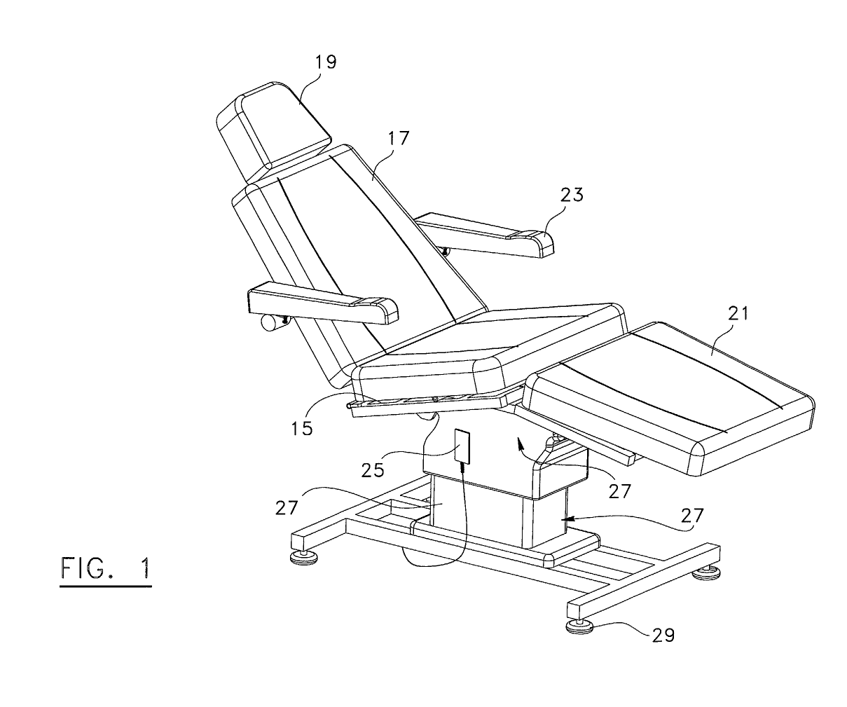

Referring now to FIG. 1, there is shown a clinical chair according to the prior art. The chair comprises a seat 15, a backrest 17, a headrest 19, a leg support 21, and side arms 23. These components and the position of the clinical chair may be adjusted spatially with respect to the base frame namely by means of a control panel 25 which controls different actuating mechanisms, generally hidden inside the covering shells 27 of the base frame, as it is known in the art. The base frame is also provided with adequate legs 29 for supporting the clinical chair.

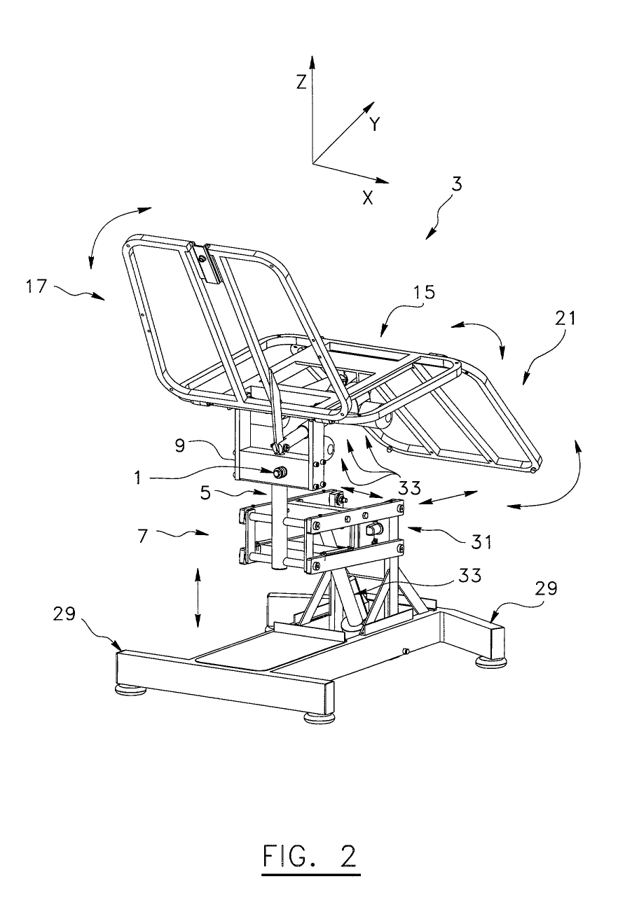

Referring now to FIG. 2, there is shown a schematic view of a chair 3 comprising a clamping device 1 according to a preferred embodiment of the invention. The chair 3 is shown in an intermediate configuration (i.e. setting and positioning of the backrest 17, leg support 21, etc.) and in a central position (i.e. rotation wise about the vertical z-axis and with respect to the longitudinal y-axis, the chair 3 being considered to be in a central position when the longitudinal axis of the chair 3 is aligned with the y-axis, as shown in FIG. 2). The configuration of the chair 3 may be adjusted spatially with respect to the base frame 7 by different mechanisms 31 and actuating means 33, as apparent to a person skilled in the art. The position of the chair 3 may also be adjusted spatially, along and about the x, y and z-axes, with respect to the base frame 7, by other mechanisms 31 and actuators 33, as also apparent to a person skilled in the art.

Similarly to the clinical chair shown in FIG. 1, the chair 3 according to the present invention, as illustrated in FIG. 2, also comprises a base frame 7 with adequate legs 29, a seat 15, a backrest 17, a leg support 21 and may be provided with a headrest 19 and side arms 23, as well as other accessories depending on the particular application of the chair 3. For example, chairs 3 used for transporting passengers such as in trains, airplanes, etc., are often provided with retractable side trays.

As better shown in FIG. 2, the chair 3 according to the present invention is devised to adjustably rotate with respect to the base frame 7 about a vertical axis thereof. This is achieved by means of the mounting block 9, the support shaft 5 of the base frame 7, the clamping means 11 and the calibrating means 13. The mounting block 9 is preferably rigidly affixed to the seat 15 of the chair 3. Preferably also, the mounting block 9, as will be explained in greater detail hereinafter, rests on the end 35 of the support shaft 5 and is devised to rotate thereon. Since the mounting block 9 is preferably rigidly secured to the seat 15 of the chair 3, when the mounting block 9 rotates about the support shaft 5, so does the chair 3, and vice-versa. Preferably, the mounting block 9 and the clamping/calibrating means 11, 13 are devised so that the chair 3 can be removably mounted onto the support shaft 5 of the base frame 7, thereby allowing the removal of the chair 3 therefrom so as to facilitate maintenance and repairs of the chair 3.

Referring now to FIGS. 3 to 5, there is shown a clamping device 1 cooperating with the support shaft 5 of the chair 3 according to a first preferred embodiment of the invention. As shown and as can be easily understood, the clamping device 1 is operatively connected to the support shaft 5 by means of its mounting block 9. As is shown also and as aforementioned, the clamping device 1 comprises clamping means 11 for clamping the support shaft 5 of the base frame 7 about which the mounting block 9 rotates and the clamping device 1 further comprises calibrating means 13 for adjusting the extent with which the clamping means 11 clamp the support shaft 5.

Preferably, the clamping means 11 consists of two jaws 37 which can he moved with respect to one another so as to adjustably clamp the support shaft 5 of the base frame 7. Each jaw 37 preferably consists of a cylindrical member 39 having a notch 41 at one end matching the contour of the support shaft 5. The support shaft 5 is preferably cylindrical, therefore the notch 41 of each jaw 37 preferably has a concave geometry, as better shown in FIG. 5. It is worth noting that other suitable shapes for the jaws 37 and support shaft 5, as well as other appropriate relationships and cooperations thereinbetween, may be used, as apparent to a person skilled in the art. Indeed, as can be easily understood, one of the main purposes of the jaws 37 is to be able to adjustably clamp the support shaft 5.

Preferably, the calibrating means 13 according to the first preferred embodiment of the invention comprise a bolt 43, a nut 45, a spring 47, and a calibrating stop block 49. The jaws 37, spring 47, and calibrating stop block 49 are preferably mounted onto the bolt 43 and secured thereon with the nut 45, as better shown in FIG. 5. The jaws 37, spring 47, and stop block 49 are compressed onto one another by screwing the bolt 43 into the nut 45. Preferably, the extent to which the bolt 43 is screwed into the nut 45 establishes the clamping force caused by the jaws 37 onto the support shaft 5. This is due, as can be easily understood, among other factors, by the return force generated by the spring 47 which is a potential energy storing device and by the stop block 49 which is devised to halt the insertion of the bolt 43 into the nut 45 at a certain point by stopping progression of one of the jaws 37 which is brought against it when the bolt 43 is threaded into the nut 45, as apparent to a person skilled in the art. The block stop 49 preferably comprises a bore 51 through which the bolt 43 is inserted. The block stop 49 preferably consists of a cylindrical body 53 about which the spring 47 is preferably co-axially mounted and further comprises a flange 55 at one end thereof with which the nut 45 and one extremity 54 of the spring 47 abut. It is worth noting that the calibrating stop block 49 is not an essential component of the present invention and is simply used to achieve an appropriately pre-established desired clamping force caused by the jaws 37, as apparent to a person skilled in the art, by delimiting the extent to which the spring 47 is compressed, as also apparent to a person skilled in the art. With the above-mentioned stop block 49, the clamping force of the jaws 37 on the support shaft 5 can thus be easily calibrated at the manufacturing stage of the device 1, or on site by an operator of the device 1 (i.e. chair 3).

As also better shown in FIGS. 3 to 5, the mounting block 9 preferably comprises a first appropriately located channel 57, preferably extending perpendicularly to the ground surface, i.e. along the z-axis, into which the support shaft 5 is inserted, and a second channel 59 into which are inserted the clamping means 11. Preferably also, the first channel 57 is provided with a recessed cavity 61 at the end into which the support shaft 5 is inserted. Preferably also, the recessed cavity 61 is rectangular-shaped, as better shown in FIG. 5, although other suitable shapes may be used. As can be easily understood, this recessed cavity 61 of the mounting block 9 is devised to cooperate with stoppers 63 provided on the support shaft 5 so as to delimit the rotational range of the mounting block 9 about the shaft 5, when the stoppers 63 are positioned inside the recessed cavity 61 and hit the peripheral border 65 thereof. Once again, the recessed cavity 61 of the mounting block 9 and the stoppers 63 of the support shaft 5 are not essential components of the present invention but are deemed to be advantageous because they prevent the chair 3 from rotating a full 360° about the support shaft 5, which is generally undesirable in clinical chairs 3, as it is known in the art. For this reason, the recessed cavity 61 and the stoppers 63 provided on the support shaft 5 are positioned, shaped, and sized so as to allow a preferred rotational range of about 30° counter clockwise in the x-y plane and 30° clockwise in the x-y plane starting from the central position, for a total preferred rotational range of 60°. It is worth noting that other suitable ranges may be used depending on the applications of the chair 3, as can be easily understood and as apparent to a person skilled in the art.

As better shown in FIGS. 6 to 8, the calibrating means 13 may take on other embodiments, that is, may not necessarily consist of the above-mentioned components. In the embodiment shown in FIGS. 6 to 8, the calibrating means 13 consist of a bolt 43, a spring 47, a calibrating stop block 49, and threading provided inside the bore 67 of the jaw 37 furthest to the head 69 of the bolt 43, said threading being devised to cooperate with the bolt 43. As can be easily understood, these components are used in a manner similar to the above-described first embodiment illustrated in FIGS. 3 to 5, as apparent to a person skilled in the art, for clamping the jaws 37 against the support shaft 5.

It is worth noting that the calibrating means 13 may consist of any other suitable components and are not limited to the ones described in the present description, as also apparent to a person skilled in the art. Furthermore, as aforementioned, although the spring 47 and calibrating stop block 49 offer substantial advantages, the roles they play are not considered as essential features of the present invention. For example, calibrating means 13 consisting of only a bolt 43 and threading provided inside the bore 67 of one of the jaws 37 could be used, similarly to the working principle of a vise, so as to adjustably clamp the jaws 37 against the support shaft 5. Furthermore, the bolt head 69 could be replaced by any other suitable means for allowing rotation, i.e. threading, of the bolt 43 and thus movement of the jaws 37 with respect to one another. For example, instead of a bolt head 69, the end of the bolt 43 could be provided with a small lever connected to the bolt body 71 so as to be able to rotate the same, whether manually or by appropriate actuating means, which may or may not be remotely controlled, and thus be able to gradually and adjustably adjust the clamping force of the jaws 37, as apparent to a person skilled in the art.

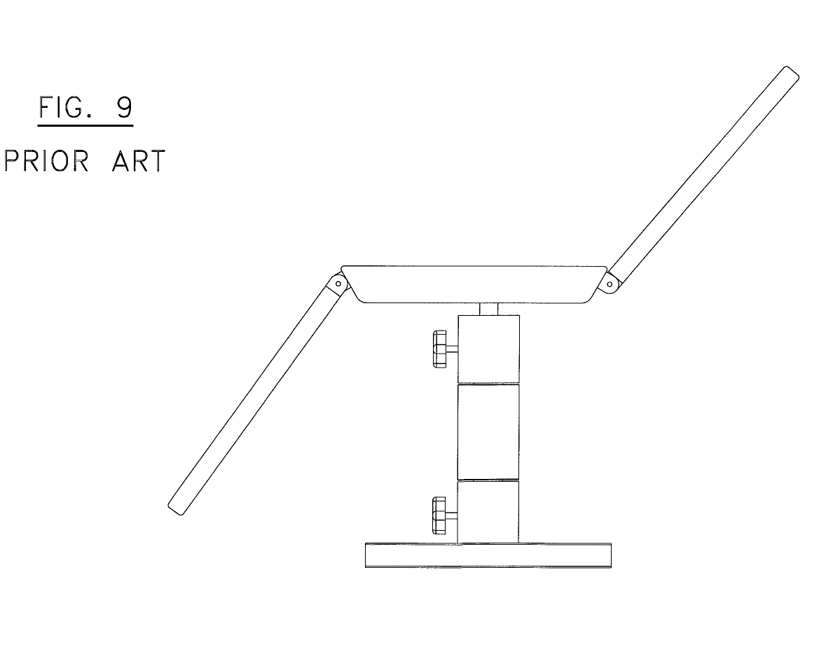

As can be seen in FIG. 9, an example of a base frame of a chair according to the prior art, having two pivot axes, namely one about the x-axis (tilt) and one about the z-axis (swivel), generally comprises a base 111, a column 112 for height adjustment, a seating surface 113, a pivot axis 114 for tilt of the seating surface 113, a pivot axis 115 for swivel of the seating surface 113, a first swivel mechanism 117, referred to as type “B”, a second swivel mechanism 118, referred to as type “A”, a lock/release mechanism 116, 110 for each swivel mechanism 117, 118, a protective covering shell 27 and corresponding slot through which the lock/release mechanisms 116, 110 project under the seating surface 113.

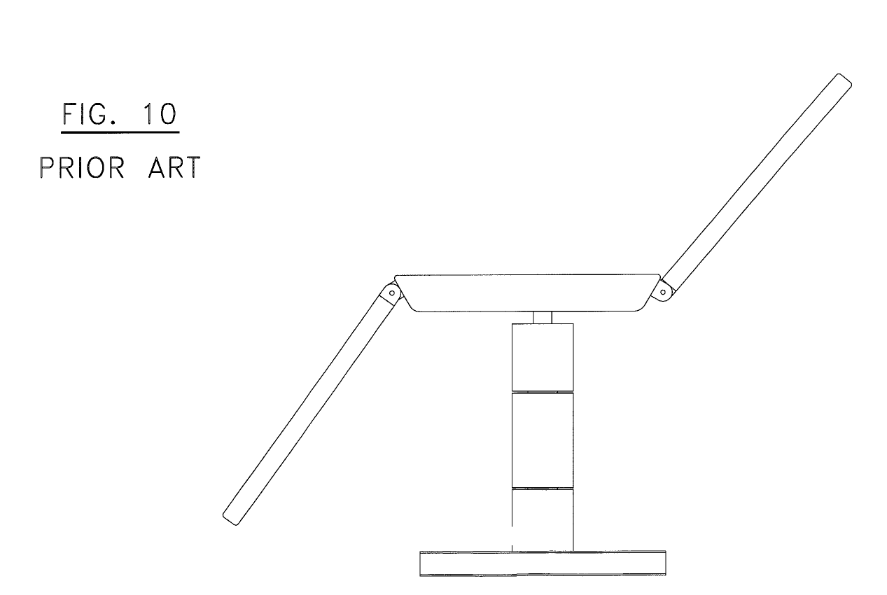

As better shown in FIG. 10, the base frame 7 of the chair 3 having a clamping device 1 according to the present invention, as explained hereinabove, preferably does not require any projecting lock/release mechanisms 116, 110 so as to be able to use a covering shell 27. Furthermore, a chair 1 may be provided with more than one clamping device 1, which may or may not be located along the same axis, as apparent to a person skilled in the art.

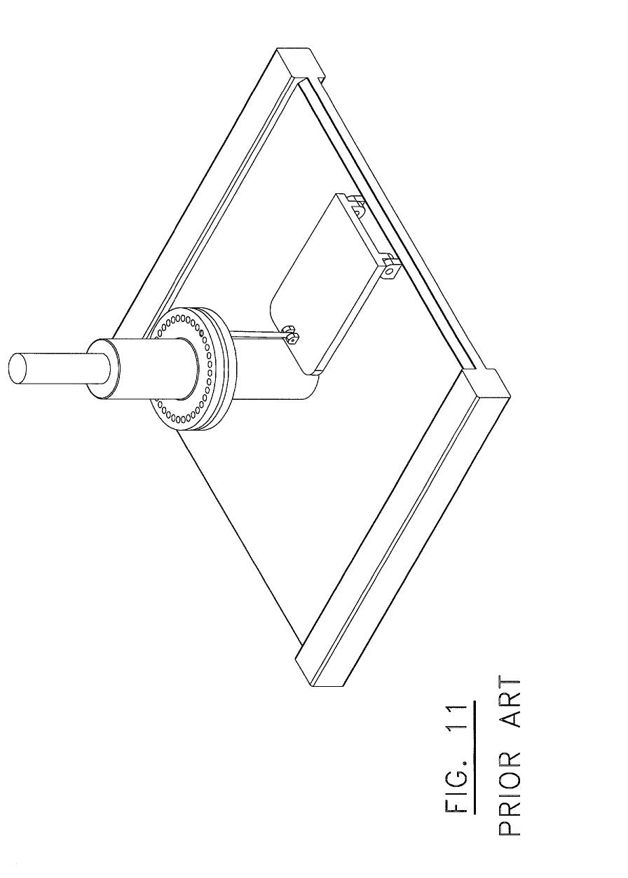

Shown in FIG. 11 is a chair using a ratchet mechanism according to the prior art. As can be seen, the chair goes through predetermined positions which are not adjustable and are limited to only certain non adjustable positions within the 360° span.

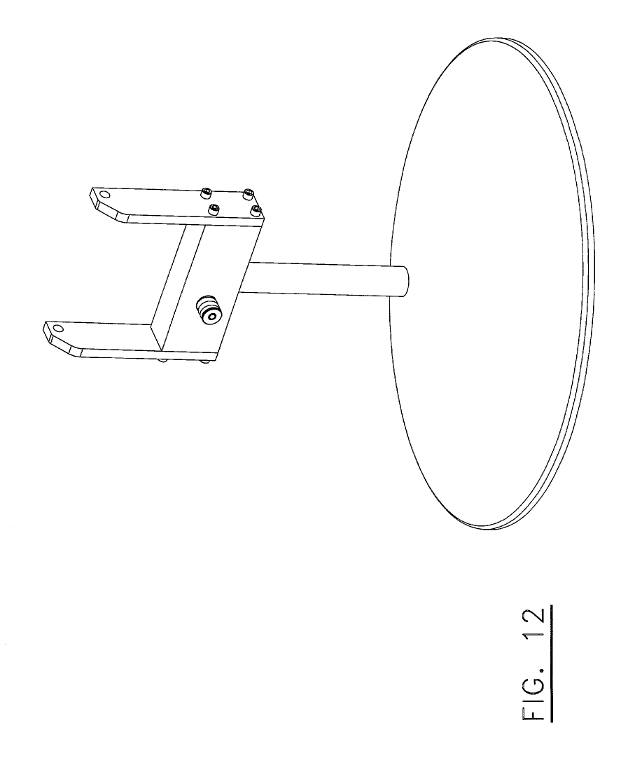

As aforementioned and as better shown in FIG. 12, the chair 3 and the base frame 7 may have different interconnections and cooperations thereinbetween depending on the application of the chair 3, with the clamping device 1 being devised accordingly, as apparent to a person skilled in the art, without departing from the scope of the present invention. As shown, for example, the support shaft 5 of the base frame 7 may be made integral thereto, that is, the support shaft 5 and the base frame 7 may consist of one single piece, or may also consist of two distinct pieces which move with respect to one another, as illustrated and as also apparent to a person skilled in the art.

As may now be appreciated, the present invention comprises several advantages and is thus a substantial improvement over the devices known in the art.

Firstly, the clamping device 1 according to the present invention enables to control rotation of the chair 3 about the support shaft 5 of the base frame 7 while providing a wide range of adjustable positions without any backlash. Indeed, the clamping device 1 is a substantial improvement in that, according to the present invention, the jaws 37 may be preset to exert an appropriate pre-established clamping force onto the support shaft 5, so that when the chair 3 is rotated, whether manually or mechanically, about the support shaft 5 to a particular position, it will maintain itself in the desired position set by the operator of the chair 3. Alternatively, the clamping device 1 according to the present invention also enables the clamping force of the jaws 37 to be controllably adjusted so as to allow the chair 3 to rotate freely about the support shaft 5 when choosing a desired position, after which the jaws 37 may be tighten securely by means of the bolt 43 preferably to block the chair 3 in the selected position, thereby preventing the chair 3 from moving. This is very advantageous when compared to the prior art in that no ratchet mechanism is used, therefore no backlash is associated with each position of the chair 3 according to the present invention. Moreover, unlike the devices known in the art which use ratchet mechanisms, the clamping device 1 according to the present invention, as explained hereinabove, enables an infinite amount of positions within a wide rotational range, as apparent to a person skilled in the art.

Furthermore, the clamping device 1 according to the present invention is also advantageous in that no external lock/release mechanism 116, 110 projecting from the covering shell 27 is required. Consequently, a covering shell 27 may be used and the chair 3 may also be allowed to move about a wider range of positions and motions, Furthermore, there is no need for an operator of the chair 3 to repeatedly lock and release a lock/release mechanism 116, 110 of the chair 3 depending on the desired positions of the chair 3, which as we know, may be very tiring and cumbersome. Therefore, the present invention allows for an easy, rapid, and calibrated rotation of the chair 3 about a vertical support shaft 5 of the base frame 7 due to its calibrated, preferably spring-loaded clamping device 1, as explained hereinabove.

Of course, numerous modifications could be made to the above-described embodiments without departing from the scope of the invention as defined in the appended claims.

1. A clamping device for controlling rotation of a chair about a support shaft of a base frame, said clamping device comprising:
a mounting block securely affixed to a bottom portion of the chair, the mounting block having first and second channels being transversally connected to one another inside the mounting block, the mounting block being pivotably mountable onto a portion of the support shaft and allowed to rotate thereabout, said portion being insertable into the first channel of the mounting block;
clamping means mounted into the second channel of the mounting block and operatively connected to the support shaft for clamping the same; and
calibrating means operatively connected to the clamping means for adjusting the extent with which the clamping means clamp the support shaft.

2. A clamping device according to claim 1, wherein the clamping means comprise first and second jaws biased against each other so as to clamp the support shaft thereinbetween, and wherein the calibrating means comprise biasing means for biasing the first and second jaws towards one another against the support shaft.

3. A clamping device according to claim 2, wherein the biasing means comprise a nut and a bolt having first and second ends, the first end of the bolt being insertable into the nut, and the jaws being mounted about the bolt between the nut and the second end of the bolt.

4. A clamping device according to claim 3, wherein the biasing means further comprise a spring mounted coaxially about the bolt, said spring being positioned adjacent to one of the jaws in an abutment relationship therewith.

5. A clamping device according to claim 4, wherein the biasing means further comprise a calibration stop block mounted coaxially about the bolt, said stop block being positioned adjacent to the spring in an abutment relationship therewith.

6. A clamping device according to claim 5, wherein the calibration stop block comprises a main body having first and second ends and a flange in an abutment relationship with the spring, the first end of main body resting against the jaw adjacent to the spring and the flange being securely affixed to the second end of the main body, and wherein the spring is further mounted coaxially about the main body of the stop block between the first end of the main body and its flange.

7. A clamping device according to claim 5, wherein the other one of the jaws and the nut are integral to one another.

8. A clamping device according to claim 2, wherein the support shaft is cylindrical and the jaws comprise clamping surfaces matching the contour of the support shaft.

9. A clamping device according to claim 1, wherein the support shaft comprises at least one stopper positioned to cooperate with a peripheral border of a recessed cavity of the mounting block.

10. A clamping device according to claim 6, wherein the support shaft is cylindrical and the jaws comprise clamping surfaces matching the contour of the support shaft, and wherein the support shaft comprise at least one stopper positioned to cooperate with a peripheral border of a recessed cavity of the mounting block.

11. A chair comprising a clamping device for controlling rotation of the chair about a support shaft of a base frame, said clamping device comprising:
a mounting block securely affixed to a bottom portion of the chair, the mounting block having first and second channels being transversally connected to one another inside the mounting block, the mounting block being pivotably mountable onto a portion of the support shaft and allowed to rotate thereabout, said portion being insertable into the first channel of the mounting block;
clamping means mounted into the second channel of the mounting block and operatively connected to the support shaft for clamping the same; and
calibrating means operatively connected to the clamping means for adjusting the extent with which the clamping means clamp the support shaft.

12. A chair according to claim 11, wherein the clamping means comprise first and second jaws biased against each other so as to clamp the support shaft thereinbetween, and wherein the calibrating means comprise biasing means for biasing the first and second jaws towards one another against the support shaft.

13. A chair according to claim 12, wherein the biasing means comprise a nut and a bolt having first and second ends, the first end of the bolt being insertable into the nut, and the jaws being mounted about the bolt between the nut and the second end of the bolt.

14. A chair according to claim 13, wherein the biasing means further comprise a spring mounted coaxially about the bolt, said spring being positioned adjacent to one of the jaws in an abutment relationship therewith.

15. A chair according to claim 14, wherein the biasing means further comprise a calibration stop block mounted coaxially about the bolt, said stop block being positioned adjacent to the spring in an abutment relationship therewith.

16. A chair according to claim 15, wherein the calibration stop block comprises a main body having first and second ends and a flange in an abutment relationship with the spring, the first end of main body resting against the jaw adjacent to the spring and the flange being securely affixed to the second end of the main body, and wherein the spring is further mounted coaxially about the main body of the stop block between the first end of the main body and its flange.

17. A chair according to claim 15, wherein the other one of the jaws and the nut are integral to one another.

18. A chair according to claim 12, wherein the support shaft is cylindrical and the jaws comprise clamping surfaces matching the contour of the support shaft.

19. A chair according to claim 11, wherein the support shaft comprises at least one stopper positioned to cooperate with a peripheral border of a recessed cavity of the mounting block.

20. A chair according to claim 16, wherein the support shaft is cylindrical and the jaws comprise clamping surfaces matching the contour of the support shaft, and wherein the support shaft comprise at least one stopper positioned to cooperate with a peripheral border of a recessed cavity of the mounting block.
